(19) United States
(12) Patent Application Publication
(10) Pub. No.: US 2008/0004147 A1
(43) Pub. Date: Jan. 3, 2008

(54) Starter

(75) Inventor: Satoshi Okada, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/802,858

(22) Filed: May 25, 2007

(30) Foreign Application Priority Data
Jun. 29, 2006 (JP) 2006-180238

(51) Int. Cl. F16H 3/72

(52) U.S. Cl. 475/149; 290/48

(57) ABSTRACT

The starter includes a motor generating a rotational torque, an output shaft disposed on the same axis with the motor and having a collar section at one end portion thereof on a side of the motor, a planetary gear reduction device operating to reduce the rotation of the motor and transmitting the reduced rotation to the collar section of the output shaft, a center case constituting a part of a housing rotatably supporting the output shaft thereinside, and a cushion member held between an internal gear of the planetary gear reduction device and the center case. The internal gear is formed with a insertion hole through which the output shaft passes, and is shaped to have a planar section axially opposed to the collar section of the output shaft, the planar section being formed with a step-like portion.

### CROSS-REFERENCE TO RELATED APPLICATION

This application is related to Japanese Patent Application No. 2006-180238 filed on Jun. 29, 2006, the contents of which are hereby incorporated by reference.

### BACKGROUND OF THE INVENTION

1. Field of the Invention The present invention relates to a starter provided with a planetary gear reduction device for reducing a rotational speed of an electric motor included therein and transmitting it to an output shaft thereof.

2. Description of Related Art

Japanese Patent Application Laid-open No. 2001-124105 discloses a starter provided with such a planetary gear reduction device. In this starter, a motor shaft and an output shaft thereof are disposed on the same axis and coupled through the planetary gear reduction device. The output shaft has a flange-like collar portion disposed at its rear end section opposed to the motor shaft. This collar portion and a bottom portion of an internal gear of the planetary gear reduction device having a cylindrical shape axially face each other.

This starter is so configured that grease filled in the planetary gear reduction device is also fed into a space formed by the bottom portion of the internal gear and the collar portion of the output shaft to lubricate the output shaft.

Japanese Patent Application Laid-open No. 2003-314418 discloses a starter of the same type in which cushion members made of rubber are provided between its internal gear and a machine frame (center case) constituting a part of a starter casing in order to lessen or absorb a reaction force applied to the internal gear when the starter starts to operate. In more detail, the cushion members are fitted between locking projections formed in a non-motor side end surface of the internal gear in order to prevent the internal gear from being rotated due to the reaction force while allowing some degree of rotational movement of the internal gear by utilizing resilient force of the cushion members between the internal gear and the machine frame.

In the conventional starters as disclosed in the Japanese Patent Applications Laid-open No. 2001-124105 and No. 2003-314418, an amount of the grease to be filled in the reduction device has to be determined allowing for the fact that the grease filled in the reduction device decreases with time because the grease leaks to the output shaft side, and the grease flies out by the high speed rotation of the output shaft. If the grease is not filled to an appropriate amount taking account of the decrease with time, the grease lubrication may be insufficient.

In addition, in the conventional starter as disclosed in Japanese Patent Application Laid-open No. 2003-314418, it is required to accurately position the internal gear in the rotational direction with respect to the cushion members and the machine frame at the time of assembling. Accordingly, in a case where an assembly apparatus is used to assemble the starter in an automated manner, a positioning unit is disposed in a space between the internal gear and the machine frame to position the internal gear at a predetermined rotational angular position by utilizing the locking projections, or convexo-concave portions formed in the non-motor side end surface of the internal gear. Next, in this state, the internal gear is held by an assembly unit, and then the positioning unit is removed from the space between the internal gear and the machine frame. After that, the assembly unit is activated to mount the internal gear to the machine frame in which the cushion members are installed. This complicated procedure prevents increasing the productivity of the starters.

### SUMMARY OF THE INVENTION

The present invention provide a starter comprising:

a motor generating a rotational torque;

an output shaft disposed on the same axis with the motor and having a collar section at one end portion thereof on a side of the motor;

a planetary gear reduction device including a sun gear formed in a rotating shaft of the motor, an internal gear disposed coaxially with the sun gear, and planetary gears meshing the sun gear and the internal gear, the planetary gear reduction device operating to reduce rotation of the motor and transmitting the reduced rotation to the collar section of the output shaft; a center case constituting a part of a housing rotatably supporting the output shaft thereinside; and

a cushion member held between the internal gear and the center case;

the internal gear being formed with a insertion hole through which the output shaft passes, and being shaped to have a planar section axially opposed to the collar section of the output shaft, the planar section being formed with a step-like portion.

According to the present invention, it is possible to provide a starter of the type including a planetary gear reduction device, which is smooth in grease lubrication in the planetary gear reduction device thereof, and easy to assemble.

The step-like portion may be a trench formed in the planar section.

The planar section may have a circular shape, and the step-like portion may be provided plurally along a circumferential direction of the planar section.

The step-like portions may be disposed equally spaced on a circle.

The step-like portion may be disposed on a center-side part of the planar section.

The internal gear may be formed in a resin molded member.

The planar section may be formed with the insertion hole, and the resin molded member may beg formed by injecting resin material into a portion of a resin mold die corresponding to the insertion hole.

The cushion member is may be made of a resilient material, and the center case and the internal gear may be so configured that rotational movement of the internal gear is restricted by abutment between the center case and the internal gear through the cushion member.

Other advantages and features of the invention will become apparent from the following description including the drawings and claims.

### BRIEF DESCRIPTION OF THE DRAWINGS

In the accompanying drawings:

FIG. 1 is a partially cross-sectional view showing an overall structure of a starter according to an embodiment of the invention;

FIG. 2A is an axial front view of an internal gear molded member in which an internal gear of a planetary gear reduction device of the starter is formed;

FIG. 2B is a cross-sectional view of the internal gear molded member as viewed along the arrow B in FIG. 2A;

FIG. 3 is an exploded perspective view showing arrangement of the internal gear, cushion members, and a center case of the starter;

FIG. 4 is a perspective view of the cushion member;

FIG. 5 is a perspective view of the center case;

FIG. 6A is a development diagram showing a state of a rotation restricting structure constituted by the internal gear molded member, cushion members and center case before the starter starts to operate; and

FIG. 6B is a development diagram showing a state of the rotation restricting structure when the starter is operating.

### PREFERRED EMBODIMENTS OF THE INVENTION

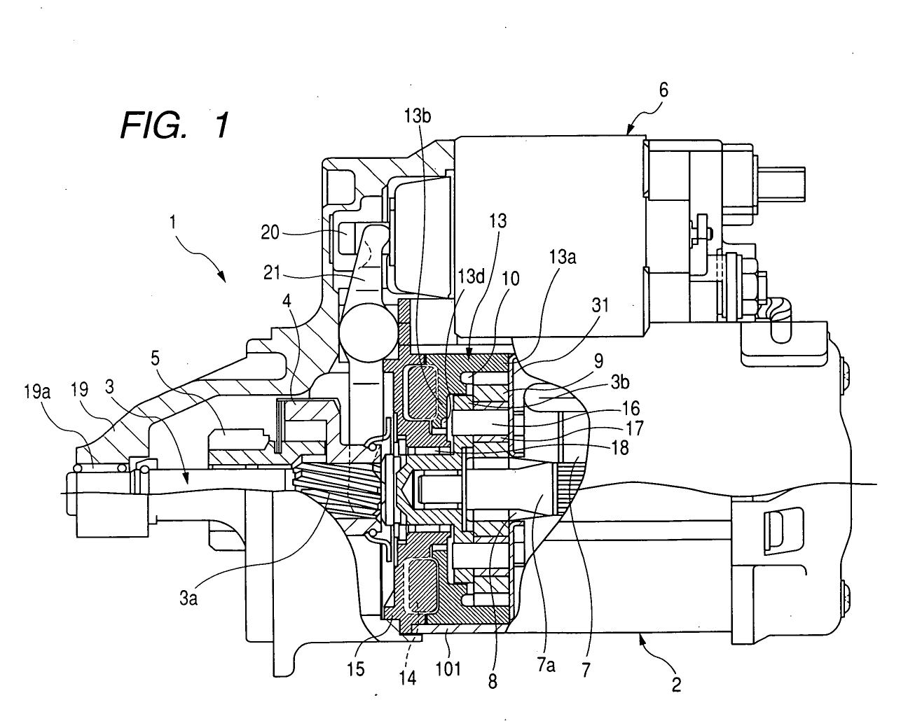

FIG. 1 is a partially cross-sectional view of a starter 1 according to an embodiment of the invention.

The starter 1 includes a motor 2 generating a torque, a planetary gear reduction device reducing a rotational speed of the motor 2, an output shaft 3 receiving an output torque of the planetary gear reduction device to rotate, a pinion gear 5 disposed on the output shaft 3 integrally with a one-way clutch 4, and an electromagnetic switch 6 for on/off controlling passage of a current to the motor 2.

The motor 2, which is a DC electric motor, generates a torque at an armature 7 thereof when a motor contact included in the electromagnetic switch 6 is closed to allow a current flows from a vehicle batter (not shown) to the armature 7.

The planetary gear reduction device includes a sun gear 8 formed in one end portion of a rotating shaft 7a of the motor 2 (referred to as an armature shaft 7a hereinafter), a ring-like internal gear 10 disposed coaxially with the sun gear 8, and a plurality of planetary gears 9 meshing with the sun gear 8 and the internal gear 10. The rotational speed of the armature shaft 7a is reduced by the rotating motions and the orbital motions of the planetary gears 9. Each planetary gear 9 is rotatably supported by a gear shaft 16 through a bearing 17. The orbital motion of the planetary gears 9 is transmitted to a collar section 3b of the output shaft 3 to which the gear shafts 16 are fixed.

The internal gear 10, which is formed in an annular molded member (referred to as an internal gear molded member hereinafter) 13, which is to be described later, meshes with the planetary gears 9, and is restricted from turning by the center case 15 through cushion members 14 (to be described later). The internal gear molded member 13 is provided with a cover plate 31 at a rear-side end surface thereof. This cover plate 31 closes a front portion of a yoke 101 of the motor 2, and restricts the internal gear molded member 13 from moving rearward.

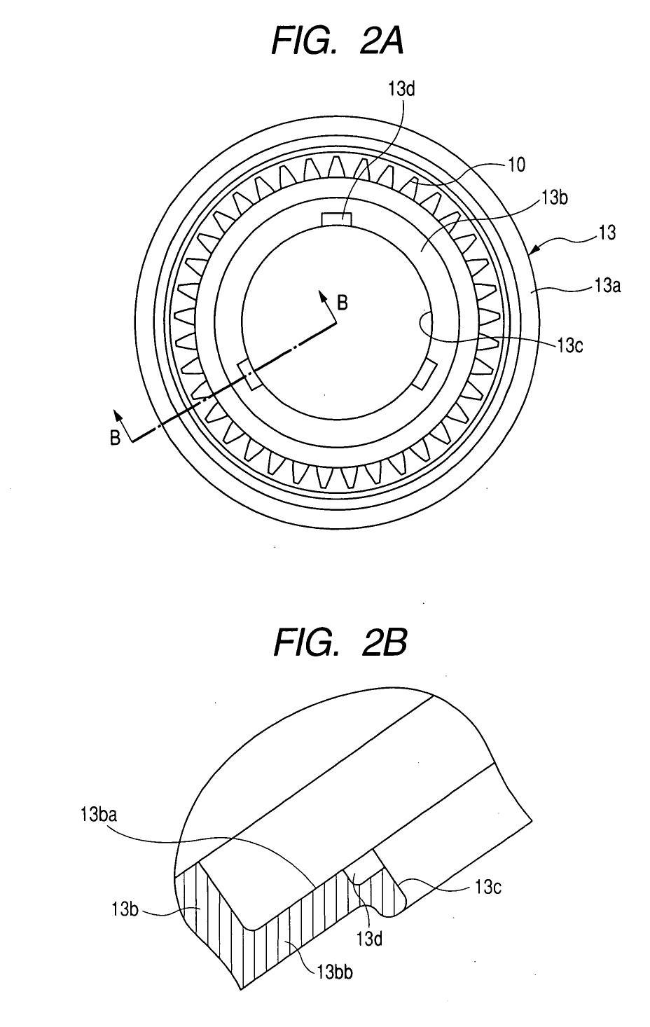

FIG. 2A is an axial front view of the internal gear molded member 13. FIG. 2B is a cross-sectional view of the internal gear molded member 13 as viewed along the arrow B in FIG. 2A. The internal gear molded member 13 is made of resin (thermoplastic resin in this embodiment), and has an annular shape. The internal gear molded member 13 includes a bottom section 13b having a cylindrical shape. The bottom section 13 has an annular bottom surface 13ba and a tubular section 13a. The internal gear 10 is formed in the inner circumference of the tubular section 13a extending toward the motor side.

The bottom section 13b is formed with an insertion hole 13c located axially opposite to the collar section 3b. The insertion hole 13c allows the output shaft 3 to be inserted therethrough from the non-motor side to the motor-side at the time of assembling. The bottom section 13b is provided with a planar section 13bb having roughly a circular shape. The output shaft 3 is mounted such that a certain clearance is provided between the collar section 13b thereof and the planar section 13bb of the internal gear molded member.

The planar section 13bb is formed with a plurality of (three in this embodiment) concave trenches 13d which serve as a grease reservoir preventing the grease charged in the planetary gear reduction device from leaking outside the planetary gear reduction device.

Although the grease reservoir is provided by forming the concave trenches 13 in the planar section 13bb in this embodiment, it may be provided by forming convex projections in the planar section 13bb. In this case, portions other than the convex projections of the planar section 13bb serve as the grease reservoir. The point is that any step-like portions in the planar section 13bb can serve as such a grease reservoir.

According to this embodiment, since the grease reservoir is provided in the form of the concave trenches 13d formed in the planar section 13bb, it is possible to provide a necessary clearance between the planar section 13bb and the collar section 3b without increasing the overall length of the starter 1 when it is required to provide such a grease reservoir between the collar section 3b and the bottom section 13b which are rotating relatively to each other.

As shown in FIG. 2A, the three trenches 13d are equally spaced along the circumferential direction (rotating direction) of the bottom surface 13ba of the planar section 13bb.

A portion in which the trenches 13d are formed (referred to as “a radial portion” hereinafter) is a part of the bottom surface 13ba of the planar section 13bb, which exists on the center axis side of the starter 2 (inner circumferential edge side of the planar section 13bb).

Although the inner circumferential edge of the planar section 13bb makes the radial portion in this embodiment, it is possible that an outer circumferential edge of the planar section 13bb makes the radial portion. Any part of the planar section 13bb axially overlapping the collar section 3b may make the radial portion.

The internal gear molded member 13 is a resin-molded part. The internal gear molded member 13 is formed by injecting resin material into a portion of a resin mold die corresponding to the insertion hole 13c(referred to as an insertion hole portion hereinafter) through a sprue. Accordingly, the internal gear molded member 13 just after being formed has gates, or unnecessary resin portions at the insertion hole portion thereof.

By positioning the internal gear molded member 13 by use of the trenches 13d at the time of trimming the gates, accuracy of punching the through hole portion and the gates can be made high.

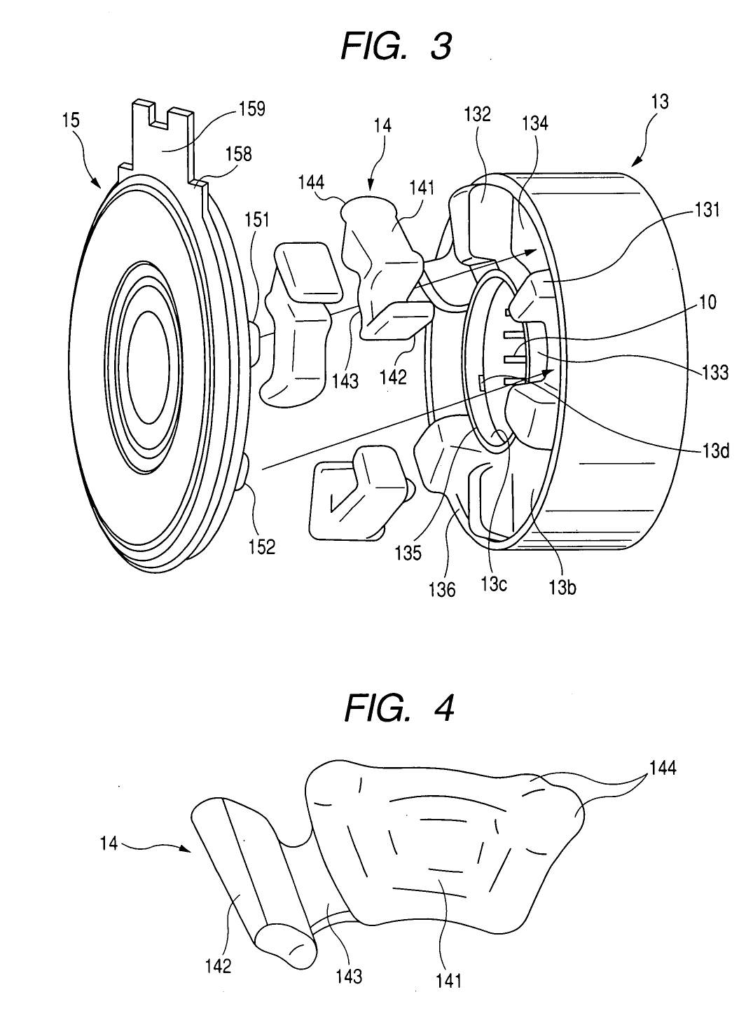

Next, the structure for restricting the rotational movement of the internal gear 10 with respect to the center case 15 (referred to as “rotation restricting structure” hereinafter) is explained with reference to FIGS. 3 to 6.

As shown in FIG. 3, the internal gear molded member 13 is provided with a plural sets (three sets in this embodiment) of movable locking projections 131 and movable abutting projections 132 at a front end surface of the bottom section 13b (the surface opposite to the bottom surface 13ba shown in FIG. 2B) so as to project axially. These movable locking projections 131 and movable abutting projections 132 are disposed alternately along the circumferential direction. The wall thickness of the movable abutting projections 132 in the circumferential direction (referred to simply as the wall thickness hereinafter) is larger than that of the movable locking projections 131.

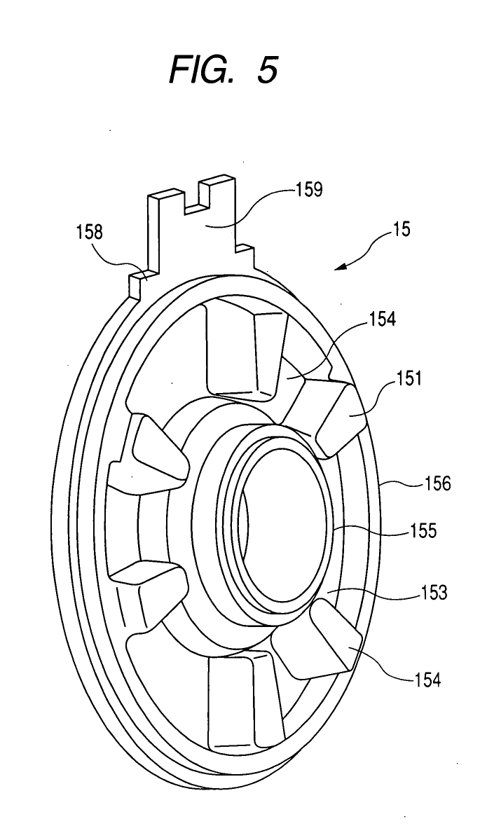

The center case 15, which may be made by die casting of aluminum alloy, has roughly a circular shape as shown in FIG. 3 and FIG. 5. The center case 15 is provided with a plural sets (three sets in this embodiment) of stationary locking projections 151 and stationary abutting projections 152 at a rear end surface thereof (the internal gear 10 side surface) so as to project axially. These stationary locking projections 151 and stationary abutting projections 152 are disposed alternately along the circumferential direction. The wall thickness of the stationary abutting projections 152 in the circumferential direction (referred to simply as the wall thickness hereinafter) is larger than that of the stationary locking projections 151.

The internal gear mold member 13 includes an inner annular projection 135 and an outer annular projection 136 as shown in FIG. 3. Likewise, as shown in FIG. 4, the center case 15 includes an inner annular projection 155 and an outer annular projection 156 corresponding to the inner annular projection 135 and the outer annular projection 136, respectively.

As shown in FIGS. 3 and 4, the cushion member 14 is constituted by a block-like main mass portion 141 , a sub-mass portion 142, and a bridge portion 143 connecting the main mass portion 141 and the sub-mass portion 142 together. The cushion member 14 may be integrally molded from oil-resisting rubber (NBR, for example). The cushion member 14 is fitted into each of the spaces between the stationary locking projections 151 and the stationary abutting projections 152 in such a state that the movable locking projection 131 of the internal gear molded member 13 is sandwiched between the main mass portion and the sub-mass portion 142.

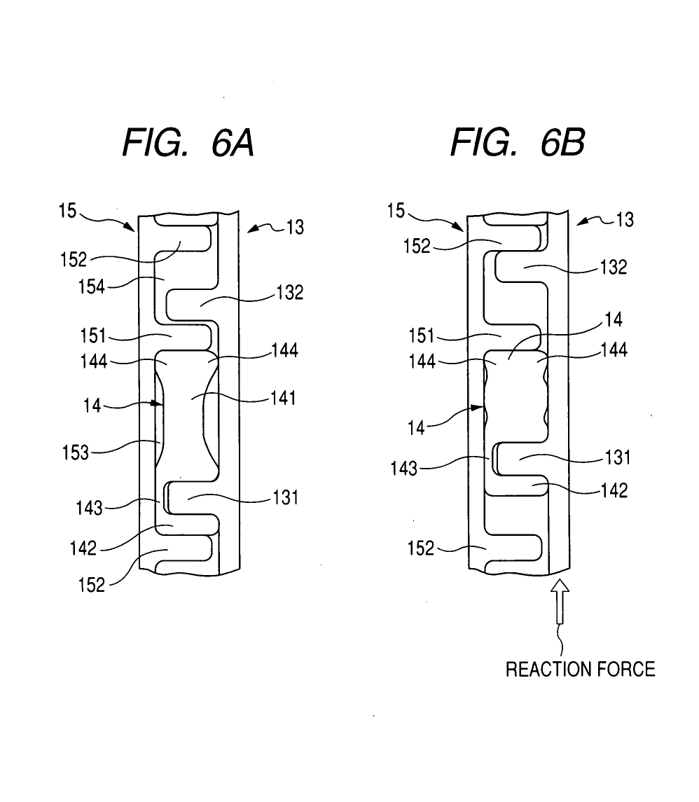

Although the number of the cushion members 14 disposed between the internal gear molded member 13 and the center case 15 is three, only one of them is shown in FIG. 6A, and FIG. 6B.

The output shaft 3 is rotatably supported by a front housing 19 through a bearing 19a at its front end portion, and supported by the center case 15 through a bearing 18 at its rear end portion (motor-side end portion). The output shaft 3 is formed with an external helical spline 3a at an outer circumference of its mid portion, and formed with the collar portion 3b at the motor side end portion thereof to which the gear shafts 16 are pressure-inserted.

The one-way clutch 4, which is a roller type clutch widely used in a starter, meshes with the external helical spline 3a formed in the outer circumference of the output shaft 3 so as to be movable in the axial direction, and coupled to a plunger (not shown) of the electromagnetic switch 6. The pinion gear 5, which is mounted integrally on the one-way clutch 4 so as to be movable in the axial direction, moves on the output shaft 3 frontward (in the leftward direction in FIG. 1) to mesh with a ring gear (not shown) of a vehicle engine at the time of starting the engine, so that the rotational force of the motor 2 is transmitted to the ring gear.

The electromagnetic switch 6 includes a coil (not shown) energized when a starter switch (not shown) is turned on, and the plunger disposed so as to be movable back and forth within this coil. When the starter switch is turned on, the coil produces an attraction force, as a result of which the plunger moves in the rightward direction in FIG. 1 while warping a return spring (not shown). This movement of the plunger drives a shift lever 21, to thereby push out the one-way clutch 4 and the pinion gear 5 to the non-motor side, and also closes the motor contact.

Next, the operation of the starter 1 is explained.

When the starter switch is turned on, the coil of the electromagnetic switch 6 is energized to attract the plunger. As a result, the pinion gear 5 is pushed frontward on the output shaft 3 together with the one-way clutch 4 by the action of the shift lever 21 until it abuts against a side surface of the ring gear. At this time, since the motor contact is closed by the movement of the plunger, the armature 7 is energized to rotate. The rotation of this armature 7 is reduced by the planetary gear reduction device and transmitted to the collar portion 3b of the output shaft 3. The rotation transmitted to the output shaft 3 is further transmitted to the pinion gear 5 through the one-way clutch 4. After that, when the pinion gear 5 rotates to a position in which it can mesh with the ring gear, the rotational torque is transmitted from the pinion gear 5 to the ring gear meshed with the pinion gear 5 to crank the engine.

When the starter switch is turned off after the engine is started up, since the coil is deenergized and accordingly the attraction force disappears, the plunger is pushed back to its original position by the action of the return spring. At this time, since the motor contact is opened by this return movement of the plunger, the armature 7 is deenergized, and the pinion gear 5 is pushed rearward on the output shaft 3 together with the one-way clutch 4 until it reaches its initial rest position.

Next, the action of the rotation restricting structure is explained.

Although the cushion members 14 are installed in a slightly compressed state, they are not compressed virtually before the starter 1 starts to operate. Accordingly, as shown in FIG. 6A, there is some clearance between the stationary abutting projections 152 of the center case 15 and the movable abutting projections 132 of the internal gear molded member 13 before the starter 1 starts to operate. Therefore, the internal gear molded member 13 can rotate with respect to the center case 15 by an angle corresponding to the clearance.

When the starter 1 starts to operate, since the rotational torque of the motor 2 is applied to the planetary gear reduction device, the internal gear molded member 13 is applied with a reaction force in the direction of an arrow shown in FIG. 6B. This reaction force causes the movable locking projection 131 of the internal gear molded member 13 to press the main mass portion 141 of the cushion member 14 in the upward direction in this figure. Since the main mass portion 141 of the cushion member 14 is resiliently held between the movable locking projection 131 of the internal gear molded member 13 and the stationary locking projection 151 of the center case 15 before the starter 1 starts to operate, this reaction force is absorbed by the main mass portion 141 through the movable locking projection 131.

When the reaction force applied to the internal gear molded member 13 through the internal gear 10 is large to such an extent that the compression rate of the main mass portion 141 reaches its maximum allowable compression rate (30%, for example), the movable abutting projection 132 of the internal gear molded member 13 abuts against the stationary abutting projection 152 of the center case 15 to prevent the main mass portion 141 from being further compressed as shown in FIG. 6B.

After the engine is started up, and the reaction force being applied to the internal gear molded member 13 is released, the internal gear molded member 13 returns from the state shown in FIG. 6B to the state shown in FIG. 6A. At this time, since the sub-mass portion 142 is disposed between the movable locking projection 131 and the stationary abutting projection 152, an impact load does not occur and operating sound is low when the internal gear molded member 13 counter-rotates.

The output shaft 3 is assembled together with the center case 15, the cushion members 14, and the planetary gear reduction device indulging the internal gear 10, etc., as an output shaft assy. The center case 15, cushion members 14, and the rotation restricting structure including the internal gear molded member 13 are assembled in an automated manner by use of an assembling apparatus (not shown). As aforedescribed, the trenches 13d formed in the planar section 13bb of the bottom section 13b of the internal gear molded member 13 are used as positioning portions for angularly positioning the internal gear molded member 13 at the time of assembling.

As explained above, in the above described embodiment, the internal gear molded member 13, in which the internal gear 10 is formed and through which the output shaft 3 passes, has the bottom section 13b located axially opposite to the collar section 3b of the output shaft 3 and formed with the concave trenches 13d which face the collar section 3b. These trenches 13d serve as a grease reservoir reserving the grease charged in the planetary gear reduction device between the collar section 3b and the bottom section 13b which are rotating relatively to each other. This enables smooth grease lubrication in the planetary gear reduction device, especially between the bottom section 13b of the internal gear molded member 13 and the collar section 3b of the output shaft 3 facing the bottom section 13b.

In addition, the concave trenches 13d formed in the planar section 13bb of the bottom section 13b of the internal gear molded member 13 can be used for positioning the internal gear molded member 13 at the time of assembling. This makes it possible not to use projections or depressions formed in the front side (center case 15 side) end surface of the internal gear molded member 13 as positioning portions unlike in the conventional assembling method that requires complicated processes. Accordingly, according to this embodiment, assembling efficiency can be improved.

Furthermore, since the grease reservoir is provided in the form of the concave trenches 13d formed in the planar section 13bb of the bottom section 13b, it is possible to provide a necessary clearance between the planar section 13bb and the collar section 3b without increasing the overall length of the starter 1 when it is required to provide such a grease reservoir between the collar section 3b and the bottom section 13b which are rotating relatively to each other.

In this embodiment, the trenches 13d are disposed along the circumferential direction (rotating direction) of the planar section 13bb of the bottom section 13b.

Accordingly, the facing area between the bottom section 13b of the internal gear molded member 3 and the collar section 3b of the output shaft 3 is smaller by the area of the trenches 13d than that of conventional starter in which no such trenches are formed. This makes it possible to reduce the sliding loss between the internal gear molded member 13 and the output shaft 3 to assure smooth relative rotation between the planetary gear reduction device and the output shaft 3.

In this embodiment, the trenches 13d are equally spaced along the circumferential direction (rotating direction) of the planar section 13bb of the bottom section 13b facing the collar section 3b. This configuration makes it possible to suppress the grease from flying, and accordingly to reduce the amount of grease to be charged.

### Other Embodiments

It is a matter of course that various modifications can be made to the above described embodiment. (1) In this embodiment, the concave trenches 13d are formed in the planar section 13bb of the bottom section 13b axially opposed to the collar section 3b of the output shaft 3. However, they may be replaced by convex portions formed in the planar section 13bb, because any step like portions in the planar section 13bb can serve as the grease reservoir and positioning portions for positioning the internal gear molded member 13 at the time assembling. (2) Although the inner circumferential edge of the planar section 13bb makes the radial portion to be formed with the trenches in this embodiment, it is possible that the outer circumferential edge of the planar section 13bb makes the radial portion. Any part of the planar section 13bb axially overlapping the collar section 3b may make the radial portion.

(3) In this embodiment, the rotation restriction structure disposed between the internal gear molded member 13 and the center case 15 to restrict the rotational movement of the internal gear molded member 13 is constituted by the locking projections 131 formed in the center case 15 and the locking projections 151 formed in the internal gear molded member 13 which project towards to each other, and hold the cushion members 14 made of resilient rubber therebetween. However, the rotation restriction structure is not limited thereto. Any structure capable of absorbing the reaction force applied to the internal gear 10 when the starter 1 starts to operate by allowing the internal gear molded member 13 to rotate to some degree with respect to the center case 15 may be used as the rotation restriction structure.

(4) Although the internal gear molded member 13 is formed by resin molding in this embodiment, it may be formed by metal sintering, or metal forging.

(5) In this embodiment, the center case 15 has been described as being formed in roughly a circular shape, however, it may be formed in a shape of a cylinder having roughly a circular bottom. In this case, the internal gear molded member is assembled in a state of being housed in the center case.

The above explained preferred embodiments are exemplary of the invention of the present application which is described solely by the claims appended below. It should be understood that modifications of the preferred embodiments may be made as would occur to one of skill in the art.

What is claimed is:

1. A starter comprising:
a motor generating a rotational torque;
an output shaft disposed on the same axis with said motor and having a collar section at one end portion thereof on a side of said motor;
a planetary gear reduction device including a sun gear formed in a rotating shaft of said motor, an internal gear disposed coaxially with said sun gear, and planetary gears meshing said sun gear and said internal gear, said planetary gear reduction device operating to reduce rotation of said motor and transmitting said reduced rotation to said collar section of said output shaft; a center case constituting a part of a housing rotatably supporting said output shaft thereinside; and
a cushion member held between said internal gear and said center case;
said internal gear being formed with a insertion hole through which said output shaft passes, and being shaped to have a planar section axially opposed to said collar section of said output shaft, said planar section being formed with a step-like portion.

2. The starter according to claim 1, wherein said step-like portion is a trench formed in said planar section.

3. The starter according to claim 1, wherein said planar section has a circular shape, and said step-like portion is provided plurally along a circumferential direction of said planar section.

4. The starter according to claim 3, wherein said step-like portions are disposed equally spaced on a circle.

5. The starter according to claim 1, wherein said step-like portion is disposed on a center-side part of said planar section.

6. The starter according to claim 1, wherein said internal gear is formed in a resin molded member.

7. The starter according to claim 6, wherein said planar section is formed with said insertion hole, said resin molded member being formed by injecting resin material into a portion of a resin mold die corresponding to said insertion hole.

8. The starter according to claim 1, wherein said cushion member is made of a resilient material, and said center case and said internal gear are so configured that rotational movement of said internal gear is restricted by abutment between said center case and said internal gear through said cushion member.
